(19) United States
(12) Patent Application Publication
(10) Pub. No.: US 2017/0362099 A1
(43) Pub. Date: Dec. 21, 2017

(54) WATER PURIFICATION VALVE MECHANISM AND SYSTEM THEREOF

(71) Applicant: Xiamen Runner Industrial Corporation, Xiamen (CN)

(72) Inventors: FENG-SHUN ZHAN, Xiamen (CN); YU-WEI LIAN, Xiamen (CN)

(21) Appl. No.: 15/624,754

(22) Filed: Jun. 16, 2017

(30) Foreign Application Priority Data
Jun. 17, 2016 (CN) 201610427094.X

(51) Int. Cl. C02F 1/42; F16K 31/04; F16K 11/074; C02F 101/10

(52) U.S. Cl. CPC C02F 1/42; F16K 11/074; F16K 31/043; C02F 2209/00; C02F 2201/005; C02F 2101/10; C02F 2303/22; C02F 2303/16

(57) ABSTRACT

A water purification valve mechanism includes a body provided with a static valve plate having therein a first passage, a second passage, a third passage, a fourth closed passage, a fifth passage, a sixth closed passage and a seventh passage respectively and radially defined through a surface of the static valve plate and a dynamic valve plate rotatably provided on top of the static valve plate, wherein the second passage, the third passage, the fourth passage, the fifth passage, the sixth passage and the seventh passage are divergently defined around the first passage; and a driving device mounted inside the body to drive the dynamic valve plate to rotate.

### CROSS REFERENCE

This application claims the priority of Chinese Application No. 201610427094.X, filed on Jun. 17, 2016 and the entirety thereof is herein incorporated with reference.

### TECHNICAL FIELD

The preferred embodiment of the present invention is related to a field of water purification and, more particularly, to a water purification valve mechanism and system thereof.

### BACKGROUND OF THE INVENTION

Nowadays, the presence of certain metal ions like calcium and magnesium principally as bicarbonates, chlorides, and sulfates in water causes a variety of problems. Hard water leads to the buildup of limescale, which can foul plumbing, and promote galvanic corrosion. In industrial scale water purifying plants, the effluent flow from the re-generation process can precipitate scale that can interfere with sewage systems. Water purification is the removal of calcium, magnesium, and certain other metal cations in hard water. The resulting water is more compatible with soap and extends the lifetime of plumbing. Water purifying is usually achieved using lime or ion-exchange resins. Water purifications are well known in the art and typically include a raw water source, a treatment tank containing an ion exchange resin, a brine tank containing a brine solution, and a control valve for directing fluids between the source, the tanks and a drain or other output.

Water purifying occurs by running water through the ion exchange resin, which replaces the calcium and magnesium cations in the water with sodium cations. As the ion exchange process continues, the resin eventually loses its capacity to treat water and must be replenished with sodium cations. The process by which the calcium and magnesium ions are removed, the capacity of the ion exchange resin to treat water is restored, and the sodium ions are replenished is known as regeneration.

The existing art, for example, US. Pat. No. 8,535,540 (540) describes a control valve device for a water purification and the system thereof, wherein the system includes a piston, wherein movement of the piston between a plurality of different positions is operative to change the flow of water through the orifices.

From the above description abstracted from '540 patent, it is to be noted that the patent is focused on the piston to control open or close of variety of orifices as well as different fluid communication between pipes or conduits.

After study current art, it is noted that numerous valve structures are provided commercially. However, they are either complicated in structure or require additional control modules to control various water purifying processes.

### SUMMARY OF THE INVENTION

It is an objective of the preferred embodiment of the present invention to provide a water purification valve mechanism adapted to be in fluid communication with a resin tank containing therein resins for water purifying. The water purification valve mechanism includes a body provided with a main inlet, a main outlet and a discharge, the body further having therein a static valve plate provided with a first passage, a second passage, a third passage, a fourth closed passage, a fifth passage, a sixth closed passage and a seventh passage respectively and radially defined through a surface of the static valve plate, wherein the second passage, the third passage, the fourth passage, the fifth passage, the sixth passage and the seventh passage are divergently defined around the first passage; and a dynamic plate rotatable relative to the static plate and having a through hole defined to selectively communicate with the second passage, the third passage, the fourth passage, the fifth passage, the sixth passage and the seventh passage and an elongated recess defined in a side face of the dynamic plate to selectively communicate the first passage with the sixth passage, the first passage with the seventh passage and the first passage with the third passage to undergo a filtration process, a reverse cleaning process and a cleansing process sequentially; and a driving device mounted inside the body to drive the dynamic valve plate to rotate relative to the static valve plate.

Another objective of the preferred embodiment of the present invention is that the driving device includes a motor, a master gear securely connected to the motor to be rotatable relative to the motor, and a planetary gear meshed with the master gear to be driven by the master gear, the planetary gear is securely connected to the dynamic valve plate to provide a driving force to the dynamic valve plate to rotate relative to the static valve plate.

Another objective of the preferred embodiment of the present invention is that a plurality photo sensors mounted inside the body and photo pads mounted on the planetary gear to allow the photo sensors to detect angular positions of the dynamic valve plate after rotation.

Another objective of the preferred embodiment of the present invention is to provide a water purification system having a body having a main inlet, a main outlet, a discharge, a static valve plate immovably located inside the body and having a first passage centrally defined through a face of the static valve plate and a first passage, a second passage, a third passage, a fourth passage, a fifth passage, a sixth passage and a seventh passage divergently and radially defined through the face thereof to have the first passage surrounded by the passages and a dynamic valve plate movable relative to the static plate and having a through hole selectively communicating with the second passage, the third passage, and the fifth passage of the static valve plate and an elongated recess defined to selectively communicate the first passage with the sixth passage, the first passage with the seventh passage and the first passage with the third passage; and a resin tank having a central tube extending therein to allow water from a water source and flowing inside the resin tank to be filtered while the through hole selectively communicates with the second passage, the third passage, and the fifth passage of the static valve plate and the elongated recess selectively communicates the first passage with the sixth passage, the first passage with the seventh passage and the first passage with the third passage.

Another objective of the preferred embodiment of the present invention is that a driving device mounted inside the body to drive the dynamic valve plate to move.

Another objective of the preferred embodiment of the present invention is that the driving device includes a motor, a master gear securely connected to the motor to be rotatable relative to the motor, and a planetary gear meshed with the master gear to be driven by the master gear, the planetary gear is securely connected to the dynamic valve plate to provide a driving force to the dynamic valve plate to rotate relative to the static valve plate.

Another objective of the preferred embodiment of the present invention is that a plurality photo sensors mounted inside the body and photo pads mounted on the planetary gear to allow the photo sensors to detect angular positions of the dynamic valve plate after rotation.

### BRIEF DESCRIPTION OF THE DRAWINGS

FIG. 1 is a schematic cross-sectional view of the water purification valve mechanism constructed in accordance with the preferred embodiment of the present invention;

FIG. 2 is still a schematic cross-sectional view of the water purification valve mechanism of the preferred embodiment of the present invention in a direction different from that of FIG. 1, wherein the through hole of the dynamic valve plate, the seventh passage and the sixth passage of the static valve plate and the main inlet are shown;

FIG. 3 is still a schematic cross-sectional view of the water purification valve mechanism of the preferred embodiment of the present invention, wherein the first passage, the second passage and the fifth passage of the static valve plate are shown;

FIG. 4 is another schematic cross-sectional view of the water purification valve mechanism of the preferred embodiment of the present invention, wherein the third passage and the fourth passage of the static valve plate are shown;

FIG. 5 is a perspective view showing the structure of the dynamic valve plate of the preferred embodiment of the present invention;

FIG. 6 is a perspective view showing the structure of the static valve plate of the preferred embodiment of the present invention;

FIG. 7 is a top plan view showing the correlation between the dynamic valve plate and the static valve plate in the filtration process;

FIG. 8 is a schematic cross-sectional view showing the internal structure of the resin tank during the filtration process;

FIG. 9 is a top plan view showing the correlation between the static valve plate and the dynamic valve plate during the reverse cleaning process;

FIG. 10 is a schematic cross-sectional view showing the internal structure of the resin tank during the reverse cleaning process;

FIG. 11 is a top plan view showing the correlation between the static valve plate and the dynamic valve plate during the cleansing process; and

FIG. 12 is a schematic cross-sectional view showing the internal structure of the resin tank during the cleansing process.

### DETAILED DESCRIPTION OF THE PREFERRED EMBODIMENT

Preferred embodiment(s) of the present invention in combination with the attached drawings shall be provided in detail in the following description. However, the given description is for example purpose only and should not be deemed as a limiting to the scope of the present invention in any way.

In order to make it easy to carry out the preferred embodiment of the present invention, a detailed description of the parts of the invention, supported with figures is provided here. As each part of the preferred embodiment of the present invention has many features, it is made easy to read, by referring to each feature with a number included in the parts description text. The number of the parts feature(s) is indicated here by starting it sequentially from the number 1, wherever a part feature appears in a text, it is directly assigned its associated serial number.

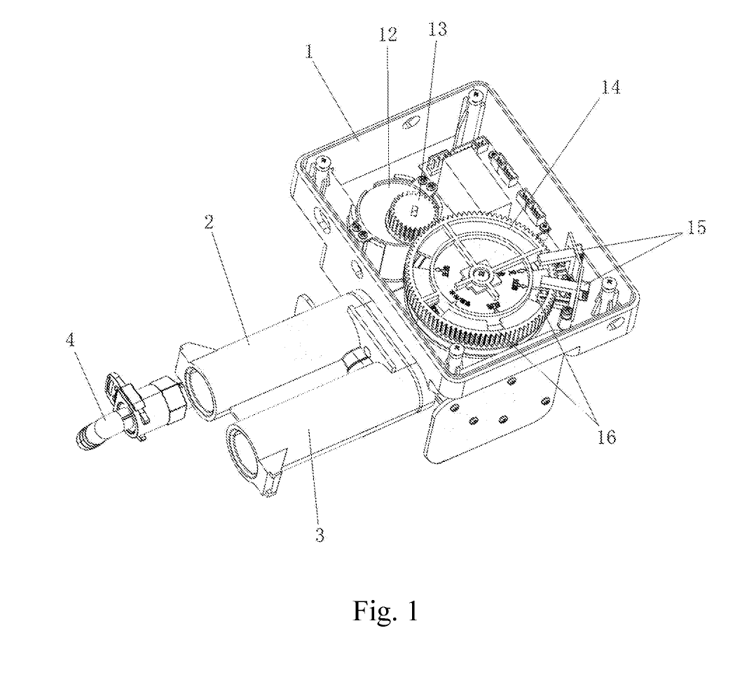

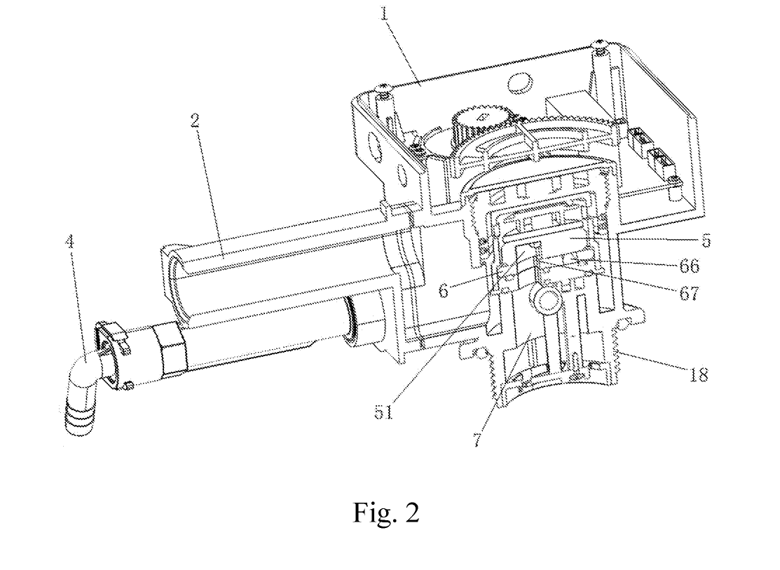

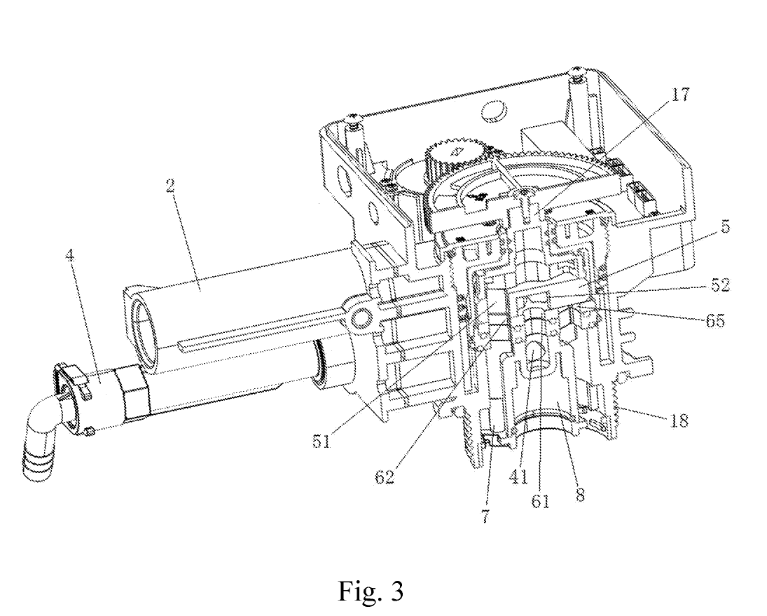

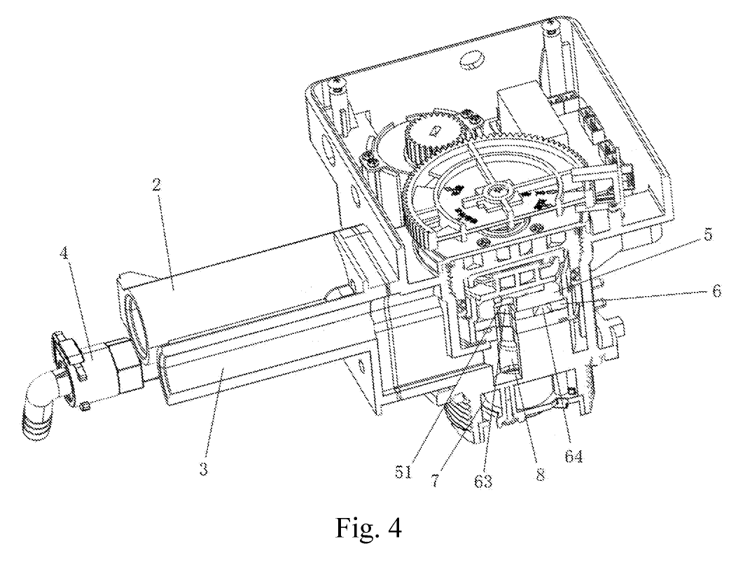

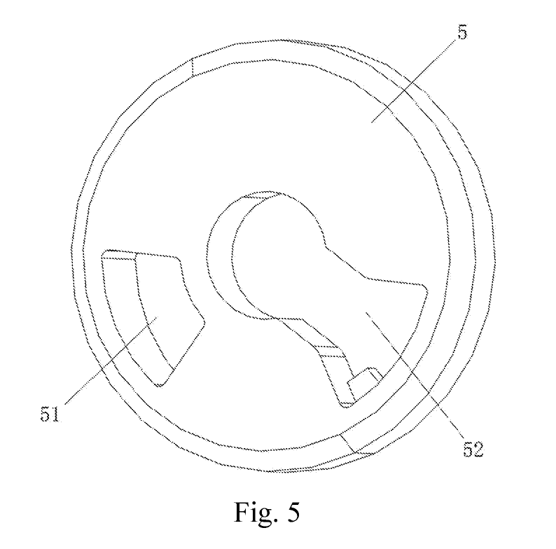

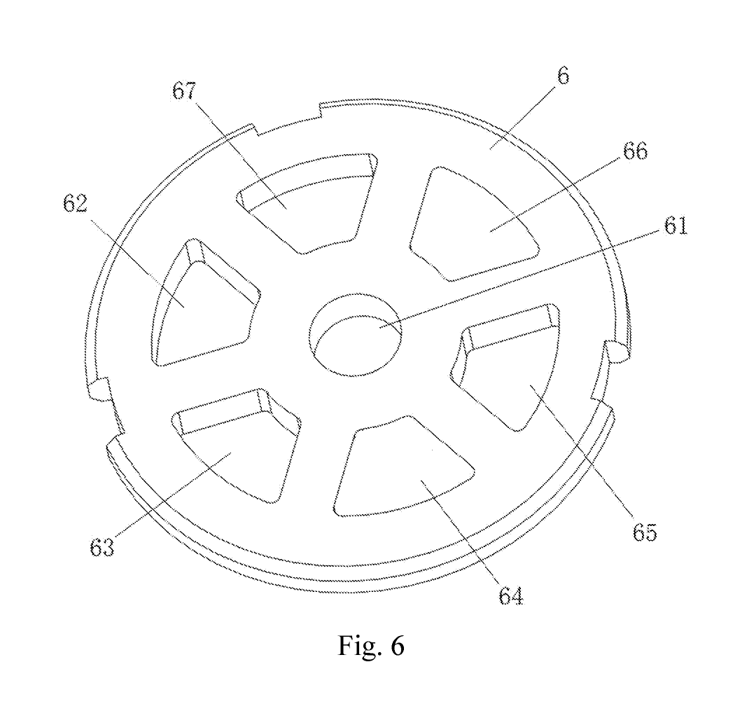

With reference to FIGS. 1-6, it is to be noted that the water purification valve mechanism constructed in accordance with the present invention has a body 1 provided with therein a main inlet 2 for connection to a faucet, a main outlet 3 and a discharge 4. At the bottom of the body 1, an outer channel 7 and an inner channel 8 are respectively defined for fluid communication with a resin tank. Furthermore, a dynamic valve plate 5 and a static valve plate 6 located beneath the dynamic valve plate 5 are installed inside the body 1, wherein the dynamic valve plate 5 is movable relative to the static valve plate 6 via a driving device. Preferably, the movement of the dynamic valve plate 5 is in a rotation movement. The dynamic valve plate 5 is, preferably, of a circular shape and has a through hole 51 in fluid communication with the main inlet 2 and an elongated recess 52. The static valve plate 6 is, too of a circular shape and has a first passage 61 defined to communicate with the discharge 4 and a second passage 62, a third passage 63, a fourth passage 64, a fifth passage 65, a sixth passage 66 and a seventh passage 67 respectively and divergently defined around the first passage 61, wherein the fourth passage 64 and the sixth passage 66 are blind holes, the second passage 62, the fifth passage 65 and the seventh passage 67 are in fluid communication with the outer channel 7, the third passage 63 is in fluid communication with the inner channel 8 which is in fluid communication with the main outlet 3. As previously described, the dynamic valve plate 5 is movable relative to the static valve plate 6, which allows the through hole 51 of the dynamic valve plate 5 to respectively communicate with each one of the second passage 62, the third passage 63, the fourth passage 64, the fifth passage 65, the sixth passage 66 and the seventh passage 67. While the dynamic valve plate 5 moves (rotate), the elongated recess 52 respectively and selectively communicates the first passage 61 with the second passage 62, the first passage 61 with the third passage 63, the first passage 61 with the fourth passage 64, the first passage 61 with the fifth passage 65, the first passage 61 with the sixth passage 66 and the first passage 61 with the seventh passage 67.

The driving device to drive the dynamic valve plate 5 to rotate includes a motor 12, a master gear 13 operably and rotatably connected to the motor 12, a planetary gear 14 meshed with the master gear 13 and having an axel 17 extended out therefrom and securely connected to the dynamic valve plate 5 to fulfill communications between different passages and waterways.

Still, inside the body 1, there are provided with photo sensors 15 mounted on an inner side of the body 1 and photo pads 16 spatially separated from each other and mounted on a face of the planetary gear 14 such that when the planetary gear 14 is rotated due to the operation of the motor 12, the photo sensors 15 are able to detect the angular position of the planetary gear 14, which specifically locate the corresponding angular position of the dynamic valve plate 5. Still, to reduce the generation of bacteria, both the dynamic valve plate 5 and the static valve plate 6 are made of ceramic material.

In the following embodiment, a resin tank 9 is provided under the valve mechanism of the preferred embodiment of the present invention with the outer channel 7 in fluid communication with an interior of the resin tank 9 and the inner channel 8 connected to a central tube 91 of the resin tank 9. It is noted that inside the resin tank 9, there is provided with active carbon 92 and quartz sand 93. At a free end of the central tube 91, a distributor 94 is mounted thereto. In order to properly connect to the resin tank 9, preferably, the body 1 has a threaded portion 18 formed on a bottom portion of the body 1 to threadingly connect to the resin tank 9. An upper cap 95 is provided to the bottom of the threaded portion 18.

Furthermore, it is understood that there are filtering phase, reverse cleaning phase and cleansing phase in the preferred embodiment of the present invention. The following description is aimed at providing a detailed operational process of the relationship between the static valve plate 6 and the dynamic valve plate 5 as well as the waterways in the valve mechanism.

### Filtering Phase:

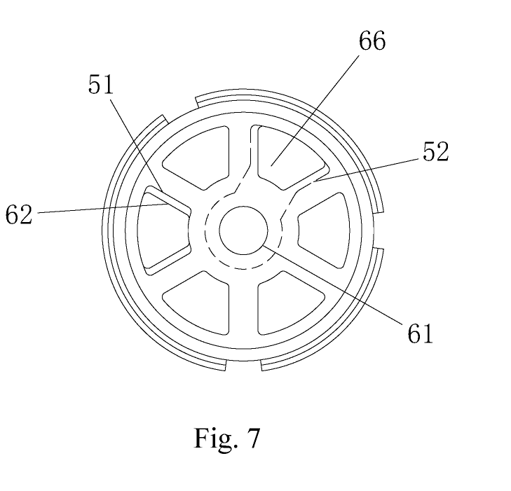

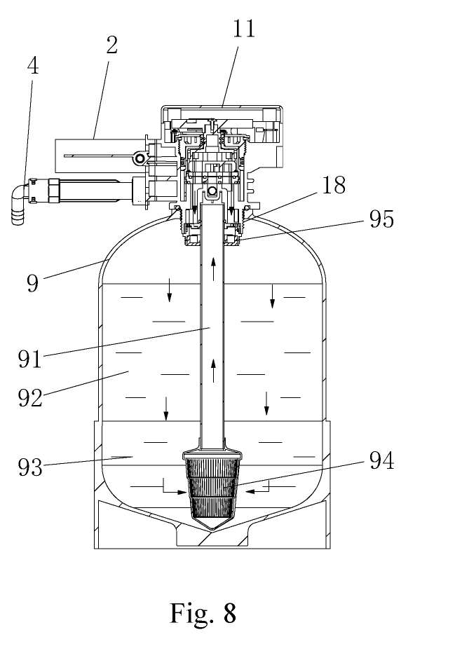

With reference to FIGS. 7 and 8, when the valve mechanism of the embodiment of the present invention is in a filtering phase, the dynamic valve plate 5 is rotated to a position where the through hole 51 is communicating with the second passage 62 and the elongated recess 52 communicates the first passage 61 and the sixth passage 66, which allows water from a water source flows through the main inlet 2 and into the through hole 51 of the dynamic valve plate 5. Then, the water continues flowing through the outer channel 7 and enters the resin tank 9. After being filtered by the resin and quartz sand inside the resin tank 9, the filtered water flows through the distributor 94, the central tube 91, the inner channel 8 and out of the valve mechanism from the main outlet 3.

### Reverse Cleaning

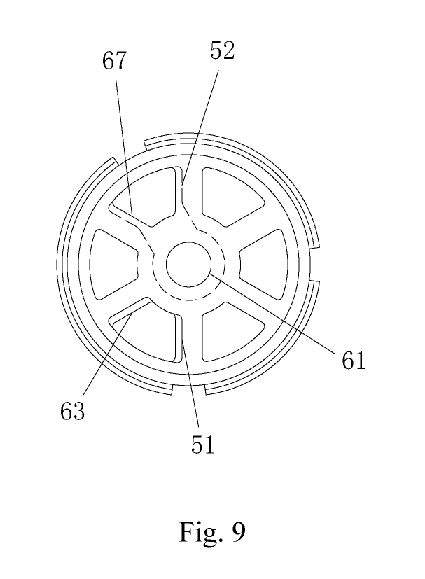

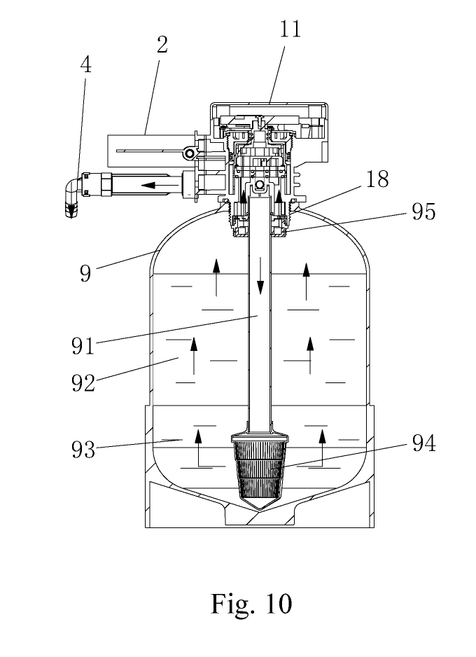

With reference to FIGS. 9 and 10, when the valve mechanism of the embodiment of the present invention is in a reverse cleaning phase, the dynamic valve plate 5 is rotated to a position where the through hole 51 is aligned with the third passage 63 and the elongated recess 52 communicates the first passage 61 with the seventh passage 67, which allows the water from the water source to flow through the through hole 51 of the dynamic valve plate 5, the inner channel 8, the central tube 91, the distributor 94, the quartz sand, the resin, the outer channel 7, the seventh passage 67 the first passage 61 and is expelled from the discharge.

### Cleansing Phase

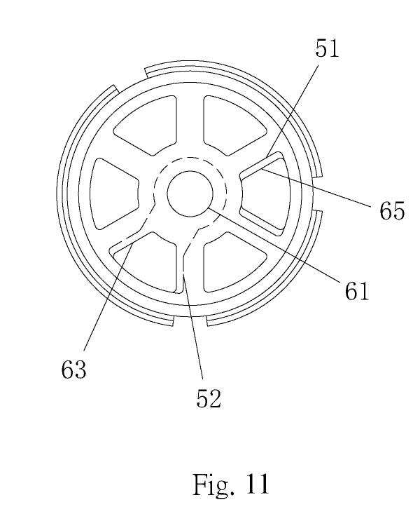

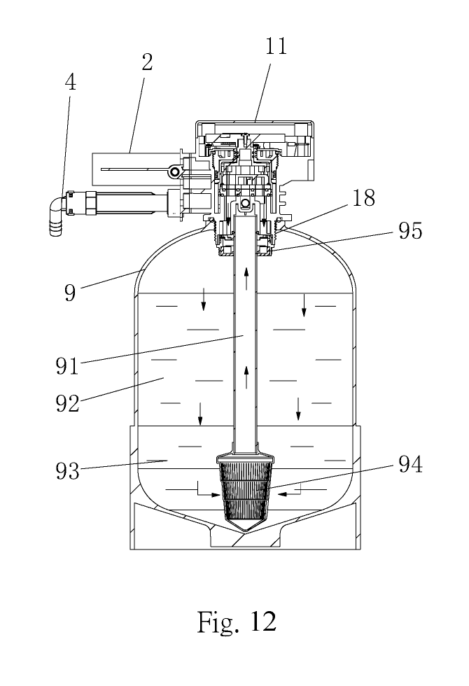

With reference to FIGS. 11 and 12, when the valve mechanism of the embodiment of the present invention is in a cleansing phase, the dynamic valve plate 5 is rotated to a position where the through hole 51 is aligned with the fifth passage 65 and the elongated recess 52 communicates the first passage 61 with the third passage 63, which allows water from the water source to flow through the main inlet 2, the through hole 51, the outer channel 7 and enters the interior of the resin tank 9. After being filtered by the resin and quartz sand inside the resin tank 9, the filtered water flows through the distributor 94, the central tube 91 and the inner channel 8. Then the filtered water continues to flow through the third passage 63 and the first passage 61 and finally is expelled from the discharge 4.

After a detailed description of the preferred embodiment(s) has been provided, any skilled person in the art would easily understand the description so provided is for example purpose only. The scope for protection of the present invention is defined by the attached claims. Any skilled person in the art would easily amend, modify or alter the elements/devices of the present invention without departing from the principle essence and spirit of the present invention. However, the amendment, modification or alteration shall fall within the protection scope sought of the present invention.

What is claimed is:

1. A water purification valve mechanism comprising:
a body provided with a main inlet, a main outlet and a discharge, the body further having therein:
a static valve plate provided with a first passage, a second passage, a third passage, a fourth closed passage, a fifth passage, a sixth closed passage and a seventh passage respectively and radially defined through a surface of the static valve plate, wherein the second passage, the third passage, the fourth passage, the fifth passage, the sixth passage and the seventh passage are divergently defined around the first passage; and
a dynamic plate rotatable relative to the static plate and having a through hole defined to selectively communicate with the second passage, the third passage, the fourth passage, the fifth passage, the sixth passage and the seventh passage and an elongated recess defined in a side face of the dynamic plate to selectively communicate the first passage with the sixth passage, the first passage with the seventh passage and the first passage with the third passage to undergo a filtration process, a reverse cleaning process and a cleansing process sequentially; and
a driving device mounted inside the body to drive the dynamic valve plate to rotate relative to the static valve plate.

2. The water purification valve mechanism as claimed in claim 1, wherein the driving device includes a motor, a master gear securely connected to the motor to be rotatable relative to the motor, and a planetary gear meshed with the master gear to be driven by the master gear, the planetary gear is securely connected to the dynamic valve plate to provide a driving force to the dynamic valve plate to rotate relative to the static valve plate.

3. The water purification valve mechanism as claimed in claim 2 further having a plurality photo sensors mounted inside the body and photo pads mounted on the planetary gear to allow the photo sensors to detect angular positions of the dynamic valve plate after rotation.

4. The water purification valve mechanism as claimed in claim 2 further having check valves installed respectively in the fourth passage, the fifth passage and the sixth passage.

5. A water purification system comprising:
a body having a main inlet, a main outlet, a discharge, a static valve plate immovably located inside the body and having a first passage centrally defined through a face of the static valve plate and a first passage, a second passage, a third passage, a fourth passage, a fifth passage, a sixth passage and a seventh passage divergently and radially defined through the face thereof to have the first passage surrounded by the passages and a dynamic valve plate movable relative to the static plate and having a through hole selectively communicating with the second passage, the third passage, and the fifth passage of the static valve plate and an elongated recess defined to selectively communicate the first passage with the sixth passage, the first passage with the seventh passage and the first passage with the third passage; and
a resin tank having a central tube extending therein to allow water from a water source and flowing inside the resin tank to be filtered while the through hole selectively communicates with the second passage, the third passage, and the fifth passage of the static valve plate and the elongated recess selectively communicates the first passage with the sixth passage, the first passage with the seventh passage and the first passage with the third passage.

6. The water purification system as claimed in claim 5 further comprising a driving device mounted inside the body to drive the dynamic valve plate to move.

7. The water purification system as claimed in claim 6, wherein the driving device includes a motor, a master gear securely connected to the motor to be rotatable relative to the motor, and a planetary gear meshed with the master gear to be driven by the master gear, the planetary gear is securely connected to the dynamic valve plate to provide a driving force to the dynamic valve plate to rotate relative to the static valve plate.

8. The water purification system as claimed in claim 7 further having a plurality photo sensors mounted inside the body and photo pads mounted on the planetary gear to allow the photo sensors to detect angular positions of the dynamic valve plate after rotation.
